(19) United States
(12) Patent Application Publication
(10) Pub. No.: US 2018/0054475 A1
(43) Pub. Date: Feb. 22, 2018

(54) LOAD BALANCING SYSTEM AND METHOD FOR CLOUD-BASED NETWORK APPLIANCES

(71) Applicant: Microsoft Technology Licensing, LLC, Redmond, WA (US)

(72) Inventors: Shekhar AGARWAL, Bellevue, WA (US); Maitrey KUMAR, Redmond, WA (US); Narayan ANNAMALAI, Redmond, WA (US); Deepak BANSAL, Sammamish, WA (US)

(21) Appl. No.: 15/238,173

(22) Filed: Aug. 16, 2016

(51) Int. Cl. H04L 29/08; H04L 12/46; H04L 29/06

(52) U.S. Cl. CPC H04L 67/1002; H04L 67/42; H04L 12/4641; H04L 67/1097

(57) ABSTRACT

A load balancing system is provided including: one or more virtual machines implemented in a cloud-based network and including a processor; and a load balancing application implemented in the virtual machines and executed by the processor. The load balancing application is configured such that the processor: receives one or more health messages indicating states of health of network appliances implemented in an appliance layer of the cloud-based network; receives a forwarding packet from a network device for an application server; based on the health messages, determines whether to perform a failover process or select a network appliance; performs a first iteration of a symmetric conversion to route the forwarding packet to the application server via the selected network appliance; receives a return packet from the application server based on the forwarding packet; and performs a second iteration of the symmetric conversion to route the return packet to the network device.

### FIELD

The present disclosure relates to cloud-based network appliances, and more particularly to availability and load balancing of cloud-based appliances.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A cloud-based network (referred to herein as “a cloud”) can include network appliances and application servers. Examples of network appliances are firewalls, proxy servers, World Wide Web (or Web) servers, wide area network (WAN) accelerators, intrusion detection system (IDS) devices, and intrusion prevention system (IPS) devices. The network appliances provide intermediary services between the application servers and client stations, which are outside the cloud. The application servers terminate connections with the user stations and host particular subscriber applications. The network appliances and application servers may be implemented as one or more virtual machines (VMs). Cloud-based networks allow computer processing and storing needs to be moved from traditional privately-owned networks to publically shared networks while satisfying data security access requirements.

### SUMMARY

A load balancing system is provided and includes: one or more virtual machines implemented in a cloud-based network and comprising a processor; and a load balancing application implemented in the one or more virtual machines and executed by the processor. The load balancing application is configured such that the processor: receives one or more health messages indicating states of health of multiple network appliances, where the network appliances are implemented in an appliance layer of the cloud-based network; receives a forwarding packet from a network device for an application server; and based on the one or more health messages, determines whether to perform at least one of a failover process or select a network appliance. The load balancing application is further configured such that the processor: performs a first iteration of a symmetric conversion to route the forwarding packet to the application server via the selected network appliance; receives a return packet from the application server based on the forwarding packet; and performs a second iteration of the symmetric conversion to route the return packet to the network device via the network appliance. During the failover process, the load balancing application is configured such that the processor switches routing of traffic between the network device and the application server through a first instance of the network appliance to routing the traffic between the network device and the application server through a second instance of the network appliance.

In other features, a load balancing system is provided and includes: one or more virtual machines implemented in a public cloud-based network and including a first processor and a second processor; a probing application implemented in the one or more virtual machines and configured such that the first processor (i) transmits probe request messages to network appliances, (ii) based on the probe request messages, receives response messages from the network appliances, and (iii) based on the response messages, generates a health report message indicating states of health of the network appliances, where the network appliances are implemented in an appliance layer of the public cloud-based network; and a first load balancing application implemented in the one or more virtual machines. The first load balancing application is configured such that the second processor: receives a forwarding packet from a network device for a first application server; based on the health report, determines whether to perform at least one of a failover process or select a first network appliance of the network appliances; and performs a first iteration of a symmetric conversion to route the forwarding packet to the first application server via the selected first network appliance; receives a return packet from the first application server based on the forwarding packet; and performs a second iteration of the symmetric conversion to route the return packet to the network device via the first network appliance. During the failover process, the first load balancing application via the second processor switches routing of traffic between the network device and the first application server through a first instance of the first network appliance to routing the traffic between the network device and the first application server through a second instance of the first network appliance.

In other features, a load balancing method for operating a load balancing system implemented in one or more virtual machines of a cloud-based network is provided. The one or more virtual machines includes a first processor and a second processor. The method includes: executing a probing application on the first processor to transmit probe request messages to network appliances, where the probing application is implemented in the one or more virtual machines; based on the probe request messages, receiving response messages from the network appliances at the first processor; and based on the response messages and via the first processor, generating a health report message indicating states of health of the network appliances, where the network appliances are implemented in an appliance layer of the cloud-based network. The method further includes: receiving a forwarding packet from a network device for a first application server at the second processor; executing a first load balancing application and based on the health report, determining via the second processor whether to perform at least one of a failover process or select a first network appliance of the network appliances. The first load balancing application is implemented in the one or more virtual machines. The method further includes: performing via the second processor a first iteration of a symmetric conversion to route the forwarding packet to the first application server via the selected first network appliance; receiving a return packet at the second processor from the first application server based on the forwarding packet; performing via the second processor a second iteration of the symmetric conversion to route the return packet to the network device via the first network appliance; and while performing the failover process and via the second processor, switching routing of traffic between the network device and the first application server through a first instance of the first network appliance to routing the traffic between the network device and the first application server through a second instance of the first network appliance.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an example of a cloud-based network including a load balancing system in accordance with an embodiment of the present disclosure.

FIG. 2 a functional block diagram of an example of a client station in accordance with an embodiment of the present disclosure.

FIG. 3 is a functional block diagram of an example of a server incorporating applications in accordance with an embodiment of the present disclosure.

FIG. 4 is a functional block diagram of example server memories in accordance with an embodiment of the present disclosure.

FIG. 5 illustrates an example overview of a public cloud servicing method in accordance with an embodiment of the present disclosure.

FIG. 6 illustrates an example service setup method in accordance with an embodiment of the present disclosure.

FIG. 7 illustrates an example health monitoring method in accordance with an embodiment of the present disclosure.

FIGS. 8A-8B illustrates an example load balancing method in accordance with an embodiment of the present disclosure.

In the drawings, reference numbers may be reused to identify similar and/or identical elements.

### DESCRIPTION

A cloud may include network appliances including one or more load balancers. The load balancer balances flow of traffic from client stations to the network appliances. Packets are routed from the client stations to the network appliances for intermediary processing prior to being received at application servers. A large number of client stations may access the network appliances during the same period. For at least this reason, high availability of the network appliances is needed. High availability includes providing access to the network appliances for the user stations during the same period while providing a high level of data throughput at a high data rate through the network appliances.

Traditionally, layer 2 (L2) protocols and custom network setups have been utilized to assure high availability of network appliances. As a first L2 example, a cloud may include network appliances, such as two load balancers that communicate with each other and share a medium access control (MAC) address. The sharing of the MAC address between two devices is referred to as “MAC address masquerading”. The load balancers transmit to each other state signals, referred to as “heartbeat signals”. The heartbeat signals indicate states of health of the load balancers. A load balancer is healthy when the load balancer is able to reliably transmit and receive packets. In operation, one of the two load balancers that is healthy transmits a network protocol signal to, for example, a router in the cloud. The router then routes packets from a user station to the healthy load balancer. Examples of the network protocol signal include a gratuitous address resolution protocol (ARP) signal and an Ethernet frame for Internet control message protocol (ICMP) or ECMP. MAC address masquerading and IP address announcement may be performed by any network appliance, such as a firewall or a load balancer to achieve high availability.

As another L2 example, two load balancers may share the same Internet protocol (IP) address. The load balancer that is healthy or, if both of the load balancers are healthy, a primary one of the load balancers transmits a routing protocol signal indicating the healthy state of the corresponding load balancer. An example of the routing protocol is an optimum selective decoding scheme (OSDS) protocol. Traffic is then routed to the load balancer that was announced as being healthy.

In certain applications, such as in a public cloud application (e.g., the cloud computing platform Microsoft® Azure®), the L2 protocols and custom network setups are not available, difficult to implement and/or are not scalable. For example, MAC address masquerading is difficult to implement in a public cloud environment due to an inability to announce MAC addresses of healthy network appliances, inability to change IP addresses of network appliances, and virtualization of load balancing. As a result, availability of network appliances can be limited. Also, network appliances are typically implemented in corresponding VMs. VMs can fail, which can further reduce availability of the network appliances. A single VM is also functionally limited, such that the VM may not be able to provide enough throughput needed for a current load of one or more network appliances.

The examples set forth below include load balancing systems and methods that provide high availability of network appliances in a public cloud. The load balancing systems perform remote health monitoring of network appliances, load balancing of packets to the network appliances, and failover processing for the network appliances. The load balancing assures that reverse flow traffic returns through the same network appliance as corresponding forward traffic. Forward traffic (or forward packets) refers to packets transmitted from a user (or client) station to an application server. Reverse flow traffic (or return packets) refers to packets transmitted from an application server to the user station based on the forward packets.

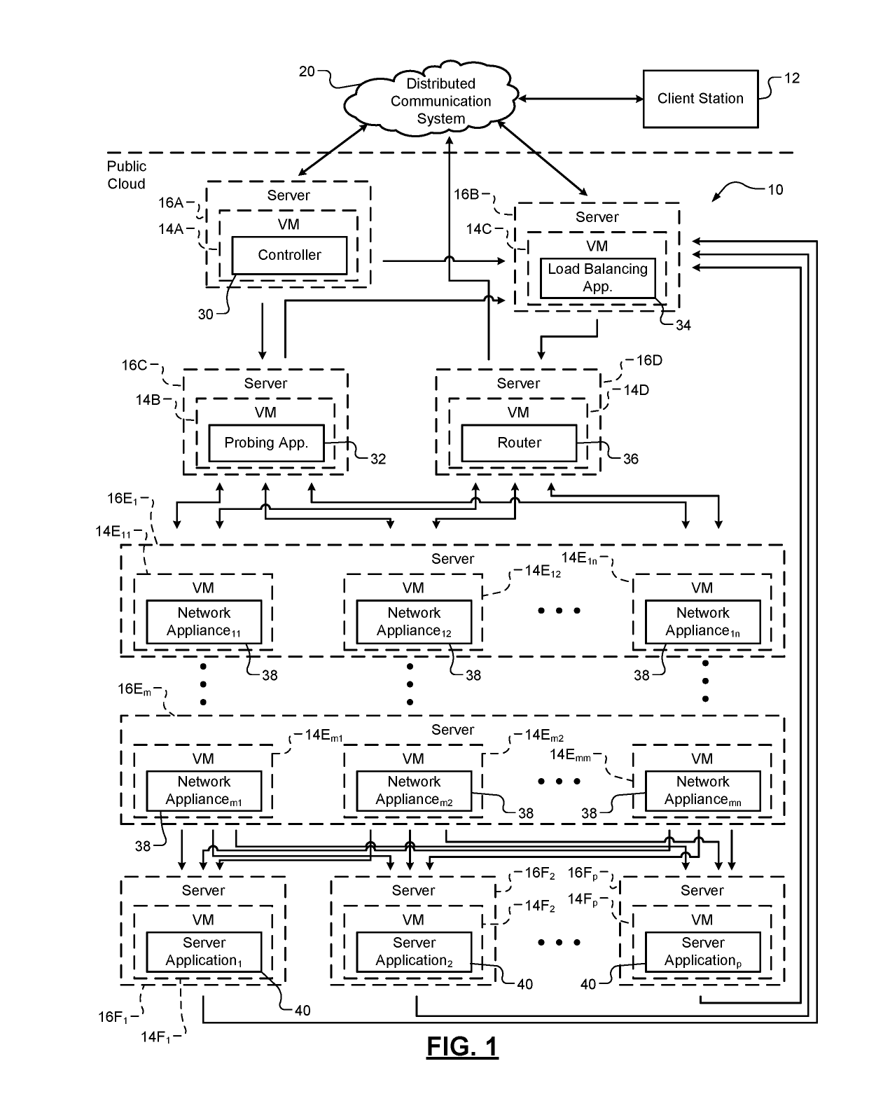

FIG. 1 shows a load balancing system 12 implemented in a public cloud and being accessed by a client station 12. A public cloud refers to a cloud-based network that includes resources that are shared by client stations including the client station 12. A service provider provides the resources, such as software applications having corresponding executable code, server processing time, and memory available to the general public over the Internet via the cloud-based network. The client stations may be privately owned by different individuals and/or entities. Examples of the client stations include personal computers, tablets, mobile devices, cellular phones, wearable devices, and/or work stations.

The public cloud includes one or more virtual machines (VMs) 14A-D, 14E₁₁₋ₘ, and 14F₁₋ₚ (collectively referred to as VMs 14) that are implemented on one or more servers 16A-D, 16E₁₋ₘ, and 16F₁₋ₚ (collectively referred to as servers 16), where m, n and p are integers greater than or equal to 1. Each of the servers 16 includes and/or has access to memory. Although a single client station is shown, any number of client stations may be included and may access the public cloud as described herein with respect to the client station 12. Also, a distributed communication system 20, which may include a network (e.g., the Internet) may be connected between the client stations and the public cloud.

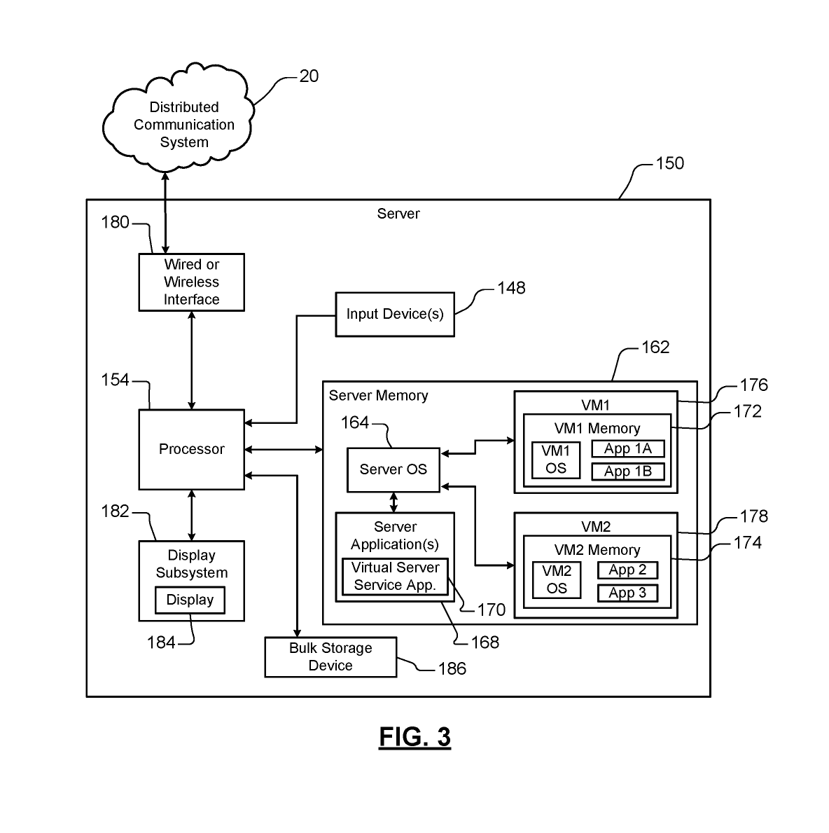

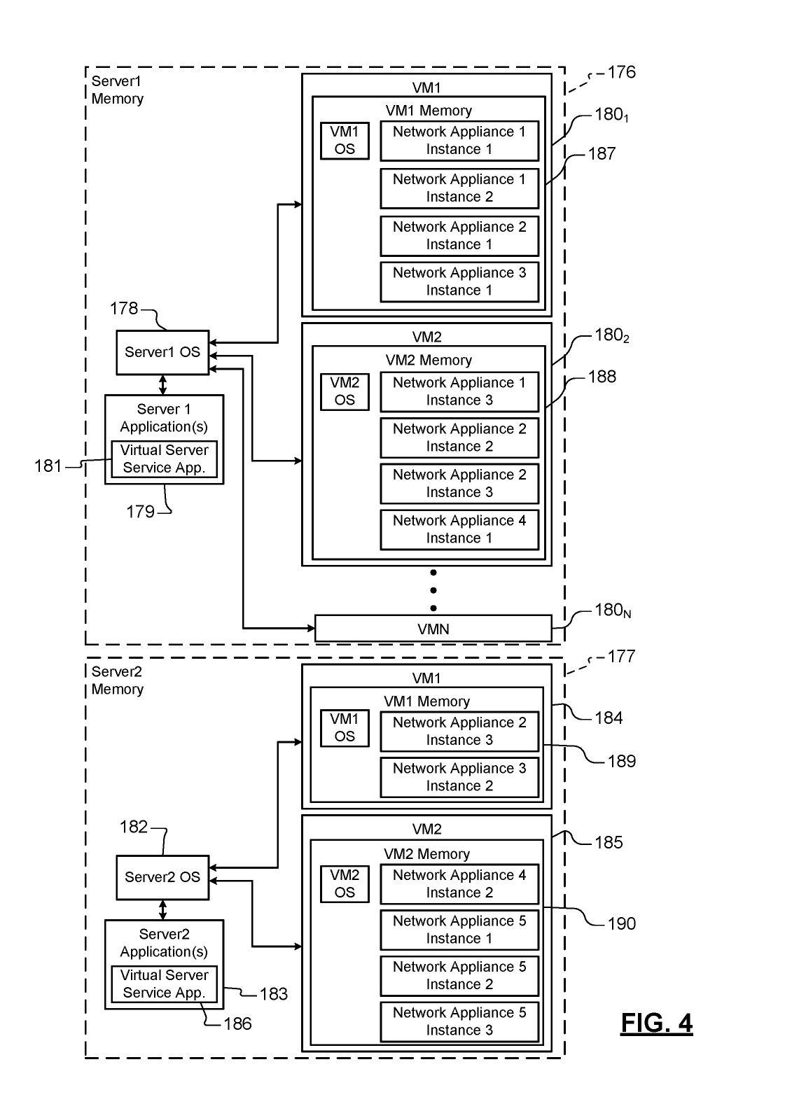

The load balancing system 10 is implemented in the public cloud and includes a controller 30, a probing application 32, a load balancing application 34, a router 36, network appliances 38, and server applications 40. Although the controller 30, probing application 32, load balancing application 34, router 36, network appliances 38, and application applications 40 are shown as being implemented in corresponding VMs and servers, the controller 30, probing application 32, load balancing application 34, router 36, network appliances 38, and server applications 40 may collectively be implemented in one or more VMs and/or in one or more servers. In one embodiment, instances of the controller 30, probing application 32, load balancing application 34, router 36, network appliances 38, and server applications 40 are grouped in any combination, where each of the combinations is implemented in a corresponding VM and one or more servers. An “instance” refers to a copy and/or another implementation of a same item. For example, the probing application 32 may be implemented multiple times in the public cloud, where each implementation is referred to as an instance of the probing application. By providing multiple instances the same services may be implemented by different VMs and/or by different servers. In another embodiment, the instances of the controller 30, probing application 32, load balancing application 34, router 36, network appliances 38, and server applications 40 are grouped in any combination, where each of the combinations is implemented in a corresponding server. Other example implementations are shown in FIGS. 3-4.

Also, although a certain number of instances of each of the controller 30, probing application 32, load balancing application 34, router 36, network appliances 38, and server applications 40 are shown in FIG. 1, any number of instances of each of the controller 30, probing application 32, load balancing application 34, router 36, network appliances 38, and server applications 40 may be included in the public cloud and associated with the client station 12 and/or any number of other client stations.

In the following description, tasks stated as being performed by the controller 30, probing application 32, load balancing application 34, router 36, network appliances 38, and server applications 40 are performed by processors associated with and/or executing the controller 30, probing application 32, load balancing application 34, router 36, network appliances 38, and server applications 40. The controller 30 may be implemented as an application and/or a module and communicates with the client station 12, the probing application 32 and the load balancing application 34 and operates to setup an account for the client station 12 and/or user of the client station 12. The controller 30 controls setup of requested services for the client station 12. The services are executed by the probing application, 32, the load balancing application 34, the network appliances 38 and the server applications 40.

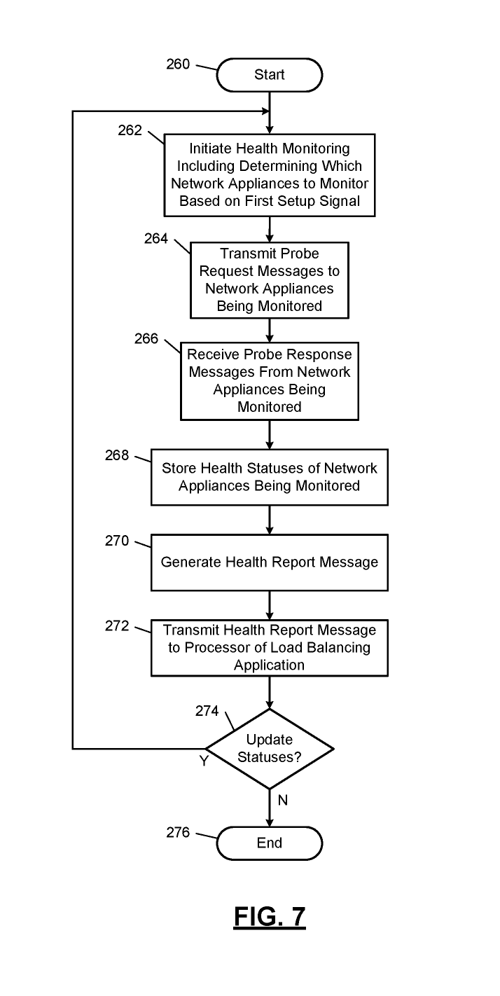

The probing application 32 monitors and tracks states of health of the network appliances 38 and reports the states of health to the load balancing application 34. The states of health indicate whether the network appliances 38 are operable to reliably receive, process and/or transmit packets. In one embodiment, reliable operation refers to receiving, processing and transmitting packets without more than a predetermined number of errors. The probing application 32 may transmit probe requests and the network appliances may respond with probe responses indicating the states of health, as is further described below with respect to the method of FIGS. 7A, 7B. The probing application 32 and the network appliances may each operate in a standby setup mode and an active setup mode. During the standby setup mode, only a primary one of the network appliance instances of a network appliance responds to probe requests. During the active setup mode, the network appliance instances that are capable of responding to the probe requests respond. The network appliances that are not healthy may respond with an unhealthy status signal, a failure signal, or may not respond to the probe requests during the active setup mode. Any number of network appliance instances of a network appliance may be active and operate in the active setup mode during the period.

The load balancing application 34 performs load balancing based on the states of health, performs symmetric conversions and controls routing of forward traffic and reverse traffic through the network appliances. A symmetric conversion includes converting a received packet based on one or more fields of the received packet to a resultant packet by adding a header to the received packet. The added header may be a service chain header (SCH). The added header includes one or more IP addresses of one or more of the network appliances. The number of IP addresses depends on the configuration of the network appliances and how many of the network appliances the received packet is to be passed through. As an example, the added header may include an IP address for each of the network appliances that the received packets are to be passed through prior to being received at one of the server applications 40.

The load balancing application 34 performs symmetric conversions to forwarding packets of forward traffic and to return packets of reverse traffic to assure that the return packets are sent through the same network appliance as the forwarding packets. If reverse flow traffic does not pass through the same network appliance as the corresponding forward traffic, the network appliance may falsely indicate that the network appliance is not healthy and/or reliable. The load balancing application 34 prevents this false indication and/or other related potential issues from occurring by routing the reverse flow traffic through the same network appliance. Reverse flow through the same network appliance becomes important when two or more network appliance instances are active and transferring packets.

The load balancing performed by the load balancing application 34 may be referred to as internal load balancing, which provides an internal load balancing virtual IP (VIP) address. The VIP address (referred to below as the IP address of a network appliance instance) is not a publically accessible IP address and is created and used by the load balancing application 34 to route packets to the network appliances 38.

The router 36 routes packets from the load balancing application 34 to the network appliances 38 based on the IP addresses in the added headers of the packets. The router 36 also routes return packets received from the server applications 40 via the load balancing application 34 to the client station 12.

The network appliances 38 are intermediary service modules and/or applications that are implemented in an appliance service layer of the public cloud and perform intermediary services which may be requested by the client station 12. The network appliances 38 may be implemented as and/or include software and/or hardware. Examples of the network appliances 38 are load balancers, firewalls, proxy servers, World Wide Web (or Web) servers, wide area network (WAN) accelerators, IDS devices, and IPS devices. One or more types of the network appliances 38 may be requested by a user (or subscriber) and associated with the client station 12. The controller 30, when setting up the account for the client station, may associate multiple instances of each of the types of network appliances requested. As an example, the network appliances 38 are shown in rows and columns, where each row may include instances of a same type of network appliance and/or implementation of a same network appliance. For example, if the client station requests application load balancing services and firewall services, the network appliances₁₁₋₁ₙ may be instances of a load balancer and the network appliances₂₁₋₂, may be instances of a firewall module, where n is an integer greater than or equal to 2. The firewall module instances may include and/or be implemented as firewalls. Multiple client stations may share the same instances of any one or more of the network appliances 38.

The server applications 40 include particular subscriber applications. The server applications 40 are implemented in an application service layer of the public cloud and are implemented in a device, VM and/or server that terminates one or more connections with the client station. Termination of a connection refers to a device, VM and/or server that is implemented as an end device and that performs an end process for a client station. No additional processing and/or subscriber applications are located downstream from the server applications 40. The server applications 40 process forwarding packets received from the client station 12 via the network appliances 38 and generate return packets, which are sent back to the client station 12. The servers in which the server applications 40 are implemented may be referred to as application servers.

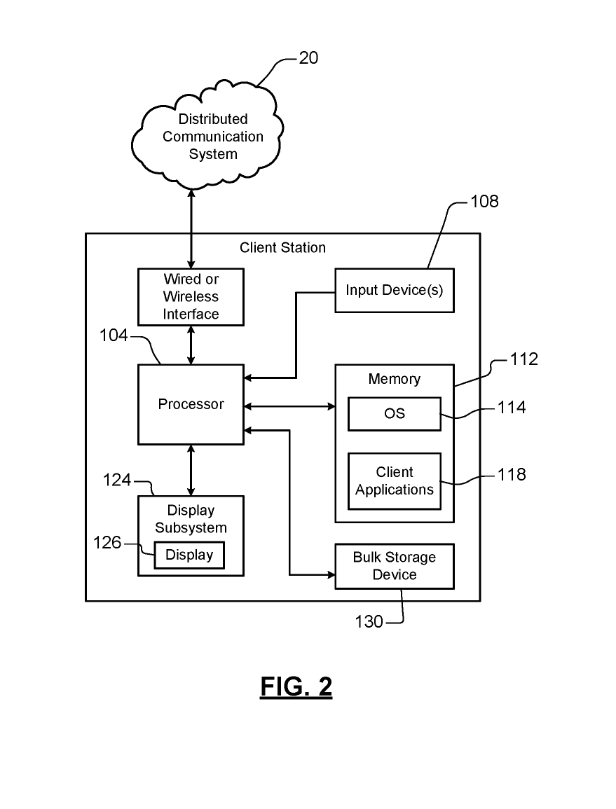

In FIG. 2, a simplified example of a client station 100 is shown. The client station 12 of FIG. 1 may be implemented as the client station 100. The client station 100 includes a central processing unit (CPU) or processor 104 and an input device 108 such as a keypad, touchpad, mouse, etc. The client station 100 further includes memory 112 such as volatile or nonvolatile memory, cache or other type of memory. The client device further includes bulk storage device 120 such as flash memory, a hard disk drive (HDD) or other bulk storage device.

The processor 104 of the client station 100 executes an operating system 114 and one or more client applications 118. The client station 100 further includes a wired interface (such as an Ethernet interface) and/or wireless interface (such as a Wi-Fi, Bluetooth, near field communication (NFC) or other wireless interface (collectively identified at 120)) that establishes a communication channel over the distributed communication system and/or network 20. The distributed system and/or network may include the Internet. The client station 100 further includes a display subsystem 124 including a display 126.

In FIG. 3, a simplified example of a server 150 is shown. Any of the servers 16 of FIG. 1 may be implemented as the server 150 and include corresponding VMs and applications. The server 150 includes one or more CPUs or processors (one processor 152 is shown in FIG. 3) and an input device 154 such as a keypad, touchpad, mouse, etc. The server 150 further includes memory 156 such as volatile or nonvolatile memory, cache or other type of memory.

The processor 152 executes a server operating system 158 and one or more server applications 160 and VM applications. An example of a server application is a virtual server service application 162, which is implemented in a virtualization layer and is executed along with the server operating system (OS) 158. The virtual server service application 162 creates a virtual environment in which VM (or guest) OSs (e.g., VM1 OS and VM2 OS) run. Example VM applications App 1A, App 1B, App 3, App 4 are shown as being implemented in VM memories 164, 166 of VMs 168, 170. The VM applications may include instances of the probing application 32, the load balancing application 34, the server applications 40 and/or applications of the controller 30 and the network appliances 38 of FIG. 1. VM applications App1A and App 1B are instances of a same VM application. Other example implementations are shown in FIG. 4. The server 150 further includes a wired or wireless interface 172 that establishes a communication channel over the distributed communication system 20. The server 150 further includes a display subsystem 173 including a display 174. The server 150 further includes a bulk storage device 175 such as flash memory, a hard disk drive (HDD) or other local or remote storage device.

FIG. 4 shows example server memories 176, 177. Each of the memories of the servers 16 of FIG. 1 and/or server 150 of FIG. 3 may be implemented as one of the memories 176, 177. In the example shown in FIG. 4, the first server memory 176 includes a first server OS 178, one or more first server applications 179, and VMs 180_{1-N}, where N is an integer greater than or equal to 2. The server applications 179 may include a virtual server service application 181. The VM 180₁ includes a first VM memory 187 storing a first VM OS (VM1 OS), first and second instances of a first network appliance, a first instance of a second network appliance, and a first instance of a third network appliance. The VM 180₂ includes a second VM memory 188 storing a second VM OS (VM2 OS), a third instance of the first network appliance, second and third instances of the second network appliance, and a first instance of a fourth network appliance. Although each of the VMs 180_{1-N} are shown having a particular number of instances of each of certain network appliances, each of the VMs 180_{1-N} may have any number of instances of each of the network appliances.

In the example shown in FIG. 4, the second server memory 178 includes a second server OS 182, one or more first server applications 183, and VMs 184, 185. The server applications 183 may include a virtual server service application 186. The VM 184 includes a first VM memory 189 storing a first VM OS (VM1 OS), a third instance of the second network appliance and a second instance of the third network appliance. The VM 185 includes a second VM memory 190 storing a second VM OS (VM2 OS), a second instance of the fourth network appliance, and first, second and third instances of a fifth network appliance.

Any of the instances of the VMs 180_{1-N} and 184, 185 and any other instances of the server memories 176, 177 may be implemented as instances of the client station 12, controller 30, probing application 32, load balancing application 34, router 36, network appliances 38, and server applications 40 of FIG. 1. One or more of the instances of the client station 12, controller 30, probing application 32, load balancing application 34, router 36, network appliances 38, and server applications 40 of FIG. 1 may be implemented as instances of server applications and may not be implemented as part of a VM.

Processors of the servers associated with the server memories 176, 178 may be in communication with each other and/or transfer data between each other via corresponding interfaces. Examples of the processors and the interfaces are shown by the processor 152 and the interface 172 of FIG. 3.

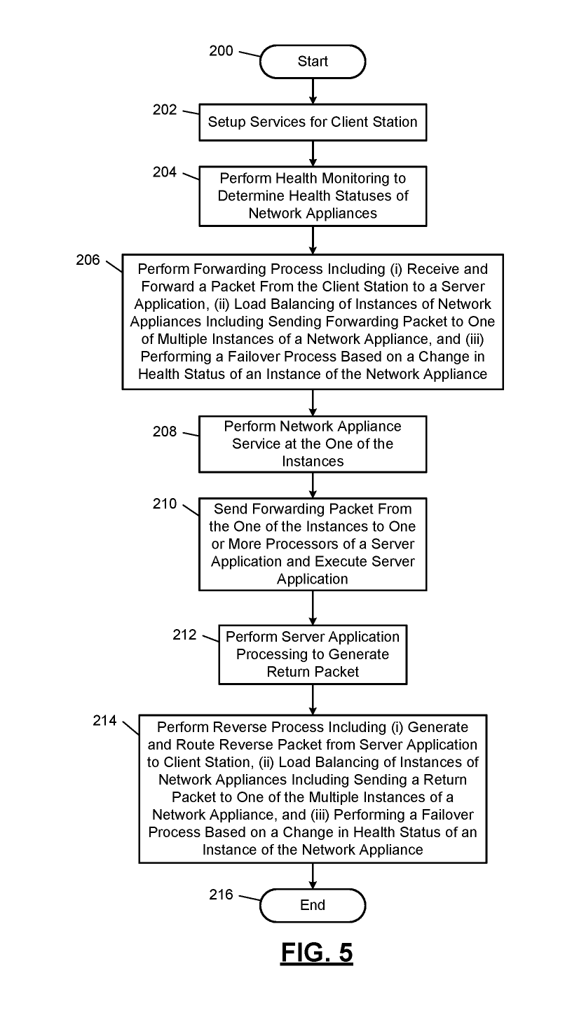

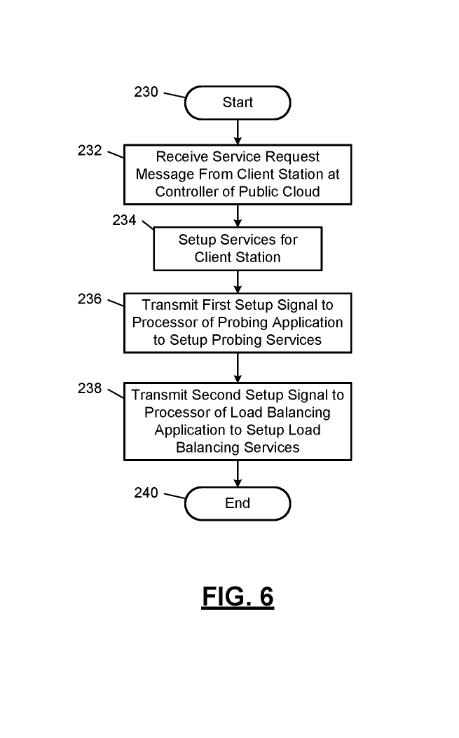

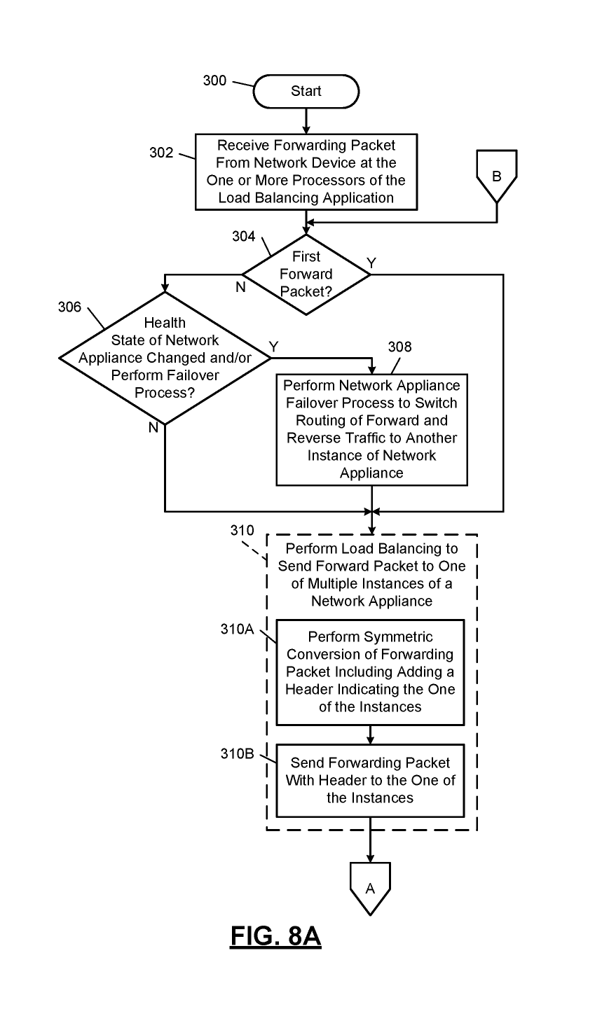

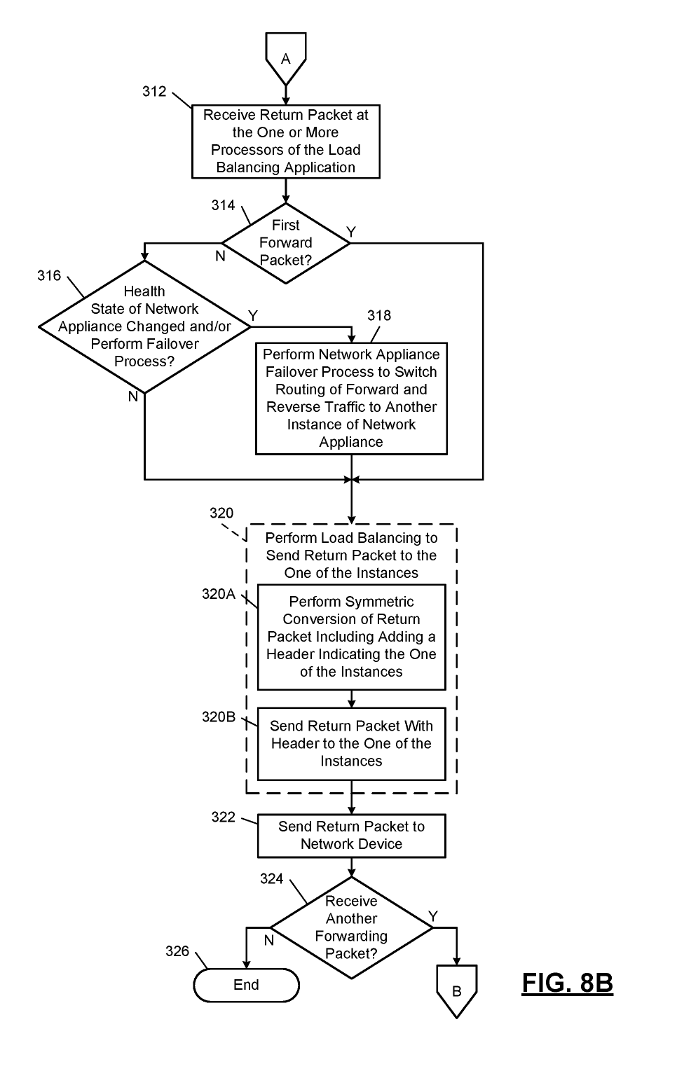

Operations of the client station 12, controller 30, probing application 32, load balancing application 34, router 36, network appliances 38, and server applications 40 of FIG. 1 are further described below with respect to the methods of FIGS. 5-8B. For further defined structure of the devices, modules, appliances, virtual machines and/or servers of the applications of FIGS. 1-4 see below provided methods of FIGS. 5-8B and below provided definitions for the terms “controller”, “processor” and “module”. The systems disclosed herein may be operated using numerous methods. An overview of an example public cloud servicing method is illustrated in FIG. 5. The tasks of FIG. 5 may be performed by one or more servers, one or more processors, and/or one or more virtual machines. Certain tasks of FIG. 5 may be implemented as respective methods, which are further described below. For example: task 202 may include the method of FIG. 6; task 204 may include the method of FIG. 7; task 206 may include the tasks described in FIG. 8A; and task 214 may include the tasks described in FIG. 8B. Although the following methods of FIGS. 5-8 are shown as separate methods, one or more methods and/or tasks from separate methods may be combined and performed as a single method.

Although the following tasks are primarily described with respect to the implementations of FIGS. 1-4, the tasks may be easily modified to apply to other implementations of the present disclosure. The tasks may be iteratively performed.

The method may begin at 200. At 202, services, such as probing services, load balancing services for network appliances (e.g., some of the network appliances 38), network appliance services, virtual machine services, server application services, etc. are setup for the client station 12. The controller 30 is configured to cause a processor executing the controller 30 to setup the services. The client station 12 requests certain services from a service provider and the service provider via a public cloud and the controller 30 sets up the requested services and/or other corresponding services. The setup of the services includes associating selected and/or predetermined numbers of selected types of instances of network appliances with the client station 12. Setup of the services is further described below with respect to the method of FIG. 6.

At 204, if health monitoring services are enabled for the client station at 202, the probing application 32 is configured to cause a processor executing the probing application 32 to monitor health statuses of the associated network appliances and report the health statuses to the load balancing application 34. In addition or as an alternative, the associated network appliances may determine respectively the health statuses and report the health statuses to the load balancing application 34. A health monitoring method that may be performed at 204 is described below with respect to FIG. 7.

At 206, a forwarding process is performed. The forwarding process includes (i) receiving and forwarding a packet from the client station 12 to one of the server applications 40, (ii) load balancing instances of network appliances, and (iii) performing a failover process for one of the instances. The load balancing of network appliances includes determining which network appliances to send forwarding packets. As described above, each of the forwarding packets includes a first header. The load balancing may include encapsulating and/or adding a second header to each of the forwarding packets, as described above. The failover process includes determining whether to change traffic flow of forwarding packets and return packets from a currently used instance of a network appliance to another instance of the currently used network appliance. This is based on a change in health status of the currently used instance. If the health status of the currently used instance degrades to a level no longer permitted for providing services, the load balancing application 34 is configured to cause a corresponding processor to change instances. The forwarding process is further described below with respect to steps 300-310 of the load balancing method shown in FIG. 8A.

Although the following tasks are primarily described with respect to processing of a single forwarding packet and a single return packet, multiple forwarding and return packets may be processed and handled by assigned instances of the associated network appliances, which are healthy. The forwarding and return packets may be handled in series or in parallel. At 208, a healthy instance of one of the network appliance that received the forwarding packet performs a corresponding network appliance service. Prior to performing task 210, the healthy instance may remove the second header and encapsulation provided during task 206.

At 210, the forwarding packet is sent from the healthy instance of the network appliance to one of the server applications 40 to perform a server application service. This may be based on a destination IP address and/or a destination IP port number in the first header of the healthy instance.

At 212, the server application that received the forwarding packet is configured to cause a processor of the server application to perform server application servicing including generation of a return packet associated with the forwarding packet.

At 214, a reverse process is performed. The reverse process includes (i) generating and routing a reverse packet from the server application, which received the forwarding packet, to the client station 12, (ii) load balancing instances of network appliances, and (iii) performing a failover process for one of the instances. The load balancing of network appliances includes determining which network appliances to send return packets. As described above, each of the return packets includes a first header. The load balancing may include encapsulating and/or adding a second header to each of the return packets, as described above. In one embodiment, the second header is a SCH. The failover process includes determining whether to change traffic flow of forwarding packets and return packets from a currently used instance of a network appliance to another instance of the currently being used network appliance. This is based on a change in health status of the currently used instance. If the health status of the currently used instance degrades to a level no longer permitted for providing services, the load balancing application 34 is configured to cause the processor of the load balancing application 34 to change instances. The reverse process is further described below with respect to steps 312-326 of the load balancing method shown in FIG. 8B. The method may end at 216.

FIG. 6 shows an example service setup method performed by the controller 30.

Although the following tasks are primarily described with respect to the implementations of FIGS. 1-5, the tasks may be easily modified to apply to other implementations of the present disclosure. The tasks may be iteratively performed.

The method may begin at 230. At 232, the processor of the controller 30 in the public cloud receives a service request message from the client station 12 to request setup of services. The client station 12 accesses the public cloud and sends a service request message to the controller 30. The service request message indicates services requested by a user. The services may include probing (or health monitoring) services of network appliances, load balancing services of network appliances, load balancing services of server applications, failover services for one or more network appliances, and/or other services associated with different types of network appliances. The other services may include failover services of one or more devices, appliances, modules, virtual machines, and/or servers in the public cloud and associated with the client station 12. The other services may also include firewall services, proxy server services, World Wide Web (or Web) server services, WAN accelerator services, IDS device services, and/or IPS device services. A customer associated with the client station 12 may move processing associated with a workload to the public cloud and request certain capabilities. The capabilities include the selected services.

At 234, the controller 30 sets up services for the client station 12. The controller 30, if probing services and load balancing services of network appliances are selected, informs the one or more processors corresponding probing application 32 and the load balancing application 34 to perform the respective services for the client station 12. This may include informing one or more processors of the probing application 32 and the load balancing application 34 a selected and/or predetermined number of instances of each network appliance and/or module in the public cloud to provide services for the client station 12. The number of instances may be indicated via (i) a first setup signal transmitted from the controller 30 to the probing application 32, as represented by task 236, and (ii) a second setup signal transmitted from the controller 30 to the load balancing application 34, as represented by task 238. The numbers of instances may be selected by the client station 12 and indicated in the service request signal. In one embodiment, the numbers of instances are not provided and predetermined numbers of instances are created and/or associated with the client station 12. The numbers of instances of the network appliances indicates to the one or more processors of the applications 32, 34 the number of network appliances to probe for health status checks and provide packets to during load balancing. The method may end at 240.

The following tasks of the methods of FIGS. 7 and 8 are described as if the client station 12 requested during the method of FIG. 6 probing services, load balancing services of network appliance, failover services of network appliances, network appliance services, and server application services. Probing services are described below with respect to at least tasks 262-274. Load balancing services of network appliances are described below with respect to at least tasks 302-324. Failover services of network appliances are described below with respect to at least task 308 and 318.

FIG. 7 shows an example health monitoring method performed by the probing application 32. Although the following tasks are primarily described with respect to the implementations of FIGS. 1-5, the tasks may be easily modified to apply to other implementations of the present disclosure. The tasks may be iteratively performed.

The method may begin at 260. At 262, the probing application 32 is configured to cause a corresponding processor of the probing application 32 to perform health monitoring. This includes determining which instances of the network appliances 38 to monitor based on the first setup signal generated by the controller 30. In the described example, the probing application 32 is operating in the active setup mode.

At 264, the probing application 32 is configured to cause the processor of the probing application 32 to transmit probe request messages to the instances of the network appliances (e.g., ones of the network appliances 38 associated with the client station 12). The probe request messages request health statuses of the network appliances.

At 266, the probing application 32 is configured to cause the processor of the probing application 32 to receive probe response messages from the instances of the network appliances 38 in response to the probe request messages. Each of the probe response messages indicates a health status of the corresponding network appliance. The health status may include a value indicating whether the network appliance is able to reliably receive, process, and/or transmit packets. The health status may also indicate whether return packets have been received for corresponding forwarding packets. A network appliance, based on the forwarding packet, may determine that a return pack is expected to be provided from a server application based on the forwarding packet. If the network appliance does not receive the return packet, the network appliance may indicate non-receipt of the return packet and/or may reduce a health status ranking of the network appliance. In one embodiment, the probe response messages are provided to the processor of probing application 32. In another embodiment, the network appliances 38 send the probe response messages and/or states of health directly to the processor of the load balancing application 34. The processor of the load balancing application 34 may be the same or a different processor than the processor of the probing application 32.

At 268, the probing application 32 is configured to cause the processor of the probing application 32 to store the health statuses of the network appliances being monitored in a memory (e.g., a memory of a server and/or a VM memory) associated with the probing application 32. The health statuses may be stored for example as a health status table relating health statuses and/or heath status rankings to the instances of the monitored network appliances. The health statuses and/or health status rankings are for more instances than the number of instances through which packets are being passed. This allows for failover processes disclosed herein.

At 270, the probing application 32 is configured to cause the processor of the probing application 32 to generate a health report message, which includes health statuses of the network appliances 38 and/or the network appliances associated with the client station 12. The health report message is generated based on content in the probe response messages. The health statuses may be provided in tabular form including health status rankings for the network appliances relative to IP addresses and/or other identifiers (e.g., port numbers, device numbers, etc.) of the network appliances 38.

At 272, the health report message is transmitted to the processor of the load balancing module 34. At 274, the probing application 32 determines whether to update health statuses of one or more of the instances of the network appliances 38. If a health status is to be updated task 262 may be performed, otherwise the method may end at 276.

FIGS. 8A-8B show an example load balancing method performed by the load balancing application 34. Although the following tasks are primarily described with respect to the implementations of FIGS. 1-5, the tasks may be easily modified to apply to other implementations of the present disclosure. The tasks may be iteratively performed.

The method may begin at 300. At 302, the load balancing application 34 is configured to cause the processor of the load balancing application 34 to receive a forwarding packet from the client station 12. In one embodiment, the forwarding packet includes a first header and a data payload. The first header includes header information, such as a source IP address of the forwarding packet, a destination IP address of the forwarding packet, a source port number, a destination port number, a protocol field, etc. The source port number and destination port number may be transmission control protocol (TCP) port numbers, user datagram protocol (UDP) port numbers, or layer four (L4) port numbers.

At 304, the load balancing application 34 is configured to cause the processor of the load balancing application 34 to determine whether the forwarding packet is a first packet received from the client station 12, which is to be transmitted to the processor of a server application. If the forwarding packet is a first forwarding packet received, task 310 is performed, otherwise task 306 is performed.

At 306, the load balancing application 34 is configured to cause the processor of the load balancing application 34 to determine whether a state of health of an instance of a network appliance has changed and/or whether to perform a failover process for the network appliance. If the health status ranking of the instance of the network appliance has degraded to a predetermined level, the load balancing application 34 initiates a failover process by performing task 308 to switch from the degraded instance of the network appliance to a healthy instance of the network appliance. If a health status ranking has not degraded, task 310 may be performed. In one embodiment, the instance is healthy when it has a health status ranking greater than the predetermined level.

At 308, the load balancing application 34 is configured to cause the processor of the load balancing application 34 to perform the failover process to change instances of the network appliance having the degraded health status ranking. As an example, if the instances are load balancers (or load balancing modules), then failover of a load balancer is performed. Both future forward traffic from the client station 12 and reverse traffic to the client station 12 are changed from the degraded instance to the healthy instance. In one embodiment, this is done by incorporating the IP address of the healthy instance in a second header added to forwarding and return packets. As examples, the second headers may be added below during tasks 310a and 320a.

The failover process that is performed for the network appliance is different than a failover process performed for a server and/or a virtual machine. The instances of the network appliance may be on different or the same servers and/or virtual machines. As an example, the instances may be implemented in the same server and/or in the same virtual machine. Thus, when a failover process of a network appliance is performed, the load balancing application 34 may not switch between servers and/or virtual machines. As another example, two or more instances of a network appliance may be on a same server and/or virtual machine while one or more other instances of the network appliance may be implemented on other servers and/or virtual machines.

At 310, the load balancing application 34 is configured to cause the processor of the load balancing application 34 to perform load balancing of network appliances. If the network appliances are load balancers, load balancing is performed for the load balancers. At 310A, based on the health report message, the probe response messages, and/or the states of health of the network appliances, the load balancing application 34 is configured to cause the processor of the load balancing application 34 to perform a symmetric conversion (or first symmetric conversion) of the forwarding packet including determining to which network appliance (or network appliance instance) to send the forwarding packet. In one embodiment, a second header is added to the forwarding packet that includes an IP address for the selected network appliance instance. The load balancing application 34 may be configured to cause the processor of the load balancing application 34 to encapsulate the forwarding packet when adding the second header to generate a first resultant packet.

In one embodiment, a hashing function is evaluated to determine the network appliance instance and/or IP address of the network appliance instance. The hash function may be implemented as and/or may be based on a symmetric function. An example, symmetric function is exclusive-OR (XOR). In one embodiment, an XOR is taken of two fields of the first header of the forwarding packet. The XOR function is symmetric because XOR of fields (a, b) is the same as XOR of fields (b, a). As an example, the fields a, b are the source IP address and destination IP address of the forwarding packet. As another example, the fields a, b are the source port number and destination port number of the forwarding packet. As an example, equation 1 may be used to determine the IP address of the network appliance instance, where H(X, XOR) is the hash function of a key X and the XOR value, n is an integer greater than or equal to 2 and represents a total number of instances of the network appliance that are associated with the client station and/or are healthy, IP is value representing the IP address of the network appliance instance selected, and mod is the modulo operation. The key X may be an integer between 0 and n. The hash function may be based on i) the XOR value, or ii) X and the XOR value. The hash function is used to map the key value X and/or the XOR value to an IP address representative value.

IP=H(X,XOR)mod n (1)

In an embodiment, the hash function is performed on a 2-tuple, 3-tuple, 4-tuple, or 5-tuple first header. The hash function may be based on one or more XOR values generated by performing the XOR operation on respective pairs of fields of the first header and/or forwarding packet. The first header may include any number of fields. A 2-tuple first header may include a source IP address and a destination IP address, where the XOR function is performed on both fields. A 3-tuple first header may include a source IP address, a destination IP address, and a protocol field, where the XOR function is performed one or more times; each time including two of the fields. A 4-tuple first header may include a source IP address, a destination IP address, a source port number, and a destination port number, where the XOR function is performed one or more times; each time including two of the fields. A 5-tuple first header may include a source IP address, a destination IP address, a source port number, a destination port number, and a protocol field, where the XOR function is performed one or more times; each time including two of the fields.

Alternative symmetric hash functions and/or symmetric conversion may be performed. As an example, a symmetric table may be used to look up the IP addressed based on one or more fields of the forwarding packet. The symmetric conversion assures that the same IP address is provided for both the forwarding packet and a return packet associated with the forwarding packet. For example, XOR of a source IP address and a destination IP address is the same as XOR of the destination IP address and the source IP address.

The load balancing application 34 may also be configured to cause the processor of the load balancing application 34 to determine the network appliance instance based on other parameters, such as health status rankings of the network appliance instances. A selection may be made between the network appliance instances with the highest health status ranking and/or with health status rankings above a predetermined health status ranking.

As another example, the selection of the network appliance instance may also be based on an amount of traffic being provided to each of the instances of the network appliance. In one embodiment, the load balancing application 34 is configured to cause the processor of the load balancing application 34 to balance the amount of traffic flow across the healthy ones of the network appliances. In an embodiment, forwarding packets and/or return packets that are associated with each other are sent through the same network appliance. At 310B, the load balancing application 34 is configured to cause the processor of the load balancing application 34 to send the forwarding packet (or first resultant packet) to the IP address of the selected network appliance instance. In one embodiment, tasks 208-212 of FIG. 5 are performed after task 310 and prior to task 312.

At 312, the load balancing application 34 is configured to cause the processor of the load balancing application 34 to receive a return packet from the server application. The return packet is generated based on the forwarding packet. The server application is configured to cause the processor of the server application to send the return packet to the load balancing application 34.

At 314, the load balancing application 34 is configured to cause the processor of the load balancing application 34 to determine whether the return packet is a first return packet received from the processor of the server application, which is to be transmitted to the client station. If the return packet is a first return packet received, task 320 is performed, otherwise task 316 is performed.

At 316, the load balancing application 34 is configured to cause the processor of the load balancing application 34 to determine (i) whether the state of health of the instance of the network appliance that received the forwarding packet has changed, and/or (ii) whether to perform a failover process for the network appliance. If the health status ranking of the instance of the network appliance has degraded to a predetermined level, the load balancing application 34 initiates a failover process by performing task 318 to switch from the degraded instance of the network appliance to a healthy instance of the network appliance. If a health status ranking has not degraded, task 320 may be performed. In one embodiment, the instance is healthy when it has a health status ranking greater than the predetermined level.

At 318, the load balancing application 34 is configured to cause the processor of the load balancing application 34 to perform the failover process to change instances of the network appliance having the degraded health status ranking. As an example, if the instances are load balancers (or load balancing modules), then failover of a load balancer is performed. Both future forward traffic from the client station 12 and reverse traffic to the client station 12 are changed from the degraded instance to the healthy instance. In one embodiment, this is done by incorporating the IP address of the healthy instance in a second header added to forwarding and return packets. As examples, the second headers may be added below during 320A.

The failover process that is performed for the network appliance is different than a failover process performed for a server and/or a virtual machine. The instances of the network appliance may be on different or the same servers and/or virtual machines. As an example, the instances may be implemented in the same server and/or in the same virtual machine. Thus, when a failover process of a network appliance is performed, the load balancing application 34 may not switch between servers and/or virtual machines. As another example, two or more instances of a network appliance may be on a same server and/or virtual machine while one or more other instances of the network appliance may be implemented on other servers and/or virtual machines.

At 320, the load balancing application 34 is configured to cause the processor of the load balancing application 34 to perform load balancing of the network appliances similarly to the load balancing described above with respect to task 310 except load balancing is performed for a return packet instead of for a forwarding packet. At 320A, based on the health report message, the load balancing application 34 is configured to cause the processor of the load balancing application 34 to perform a symmetric conversion (or second symmetric conversion) of the return packet including determining to which network appliance (or network appliance instance) to send the return packet. The conversion process used for the return packet is the same as the conversion process used for the forwarding packet to assure that the return packet is sent back through the same network appliance as the forwarding packet. In one embodiment, a second header is added to the return packet that includes an IP address for the selected network appliance instance. The load balancing application 34 may be configured to cause the processor of the load balancing application 34 to encapsulate the return packet when adding the second header to generate a second resultant packet.

In one embodiment, the hashing function used at 310 is evaluated to determine the network appliance instance and/or IP address of the network appliance instance. The hash function may be implemented as and/or may be based on the symmetric function and be used to provide a same IP address as determined at 210. The XOR function may be used. In one embodiment, an XOR is taken of two fields of the first header of the return packet. As an example the fields are the source IP address and destination IP address of the return packet. As another example, the fields are the source port number and destination port number of the return packet. As an example, equation 1 may be used to determine the IP address of the network appliance instance.

In an embodiment, the hash function is performed on a 2-tuple, 3-tuple, 4-tuple, or 5-tuple first header of the return packet. The hash function may be based on one or more XOR values generated by performing the XOR operation on respective pairs of fields of the return packet and/or the first header of the return packet. The first header may include any number of fields. A 2-tuple first header may include a source IP address and a destination IP address, where the XOR function is performed on both fields. A 3-tuple first header may include a source IP address, a destination IP address, and a protocol field, where the XOR function is performed one or more times; each time including two of the fields. A 4-tuple first header may include a source IP address, a destination IP address, a source port number, and a destination port number, where the XOR function is performed one or more times; each time including two of the fields. A 5-tuple first header may include a source IP address, a destination IP address, a source port number, a destination port number, and a protocol field, where the XOR function is performed one or more times; each time including two of the fields.

Alternative symmetric hash functions and/or symmetric conversion may be performed during task 320A. As an example, a symmetric table may be used to look up the IP addressed based on one or more fields of the return packet.

The load balancing application 34 may be configured to cause the processor of the load balancing application 34 to determine the network appliance instance based on other parameters, such as health status rankings of the network appliance instances. A selection may be made between the network appliance instances with the highest health status ranking and/or with health status rankings above a predetermined health status ranking. As another example, the selection of the network appliance instance may also be based on an amount of traffic being provided to each of the instances of the network appliance. In one embodiment, the load balancing application 34 is configured to cause the processor of the load balancing application 34 to balance the amount of traffic flow across the healthy ones of the network appliances. At 320B, the load balancing application 34 is configured to cause the processor of the load balancing application 34 to send the return packet (or second resultant packet) to the IP address of the selected network appliance instance.

At 322, the network appliance instance sends the return packet to the client station via the router 36. Prior to sending the return packet to the router 36, the network appliance instance may remove the second header and encapsulation provided during task 320A.

At 324, the load balancing application 34 is configured to cause the processor of the load balancing application 34 to determine whether another packet has been received by the client station 12. If another packet has been received, task 304 is performed; otherwise the method may end at 326. Tasks 302-324 may be performed in an overlapping manner and/or multiple versions of tasks 302-324 may be performed in parallel. For example, in one embodiment, tasks 302-324 are performed for subsequent packets prior to completion of tasks 302-324 for previous packets. This increases transfer rates.

The above-described tasks of FIGS. 5-8B are meant to be illustrative examples; the tasks may be performed sequentially, synchronously, simultaneously, continuously, during overlapping time periods or in a different order depending upon the application. Also, any of the tasks may not be performed or skipped depending on the implementation and/or sequence of events.

The above-described method is network service header (NSH) compatible. The symmetric conversions described may include performing a symmetric conversion of one or more fields of a NSH of a packet. The described failover processes, load balancing of network appliances, and health status monitoring and reporting are compatible with packets having NSHs.

The above-described method provides a load balancing system and method that provides high availability of network appliances and ensures reverse traffic flow passes through a same network appliance instance as corresponding forwarding packets. A load balancer is provided that operates in an standby setup mode or an active setup mode and while in the active setup mode provides a n-active failover solution, where n is an integer greater than or equal to 2 and represents a number of instances of a network appliance. If n instances are provided, as many as n−1 backup instances of the network appliance are provided. In one embodiment, a symmetric has function including an XOR of a 5-tuple is performed to ensure reverse traffic is affinitized to a same network appliance instance as corresponding forward traffic.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the terms “module”, “processor” and/or “controller” may be replaced with the term “circuit.” The term terms “module”, “processor” and/or “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

A module, processor and/or controller may include one or more interface circuits. In some examples, the interface circuits may include wired or wireless interfaces that are connected to a local area network (LAN), the Internet, a wide area network (WAN), or combinations thereof. The functionality of any given module, processor and/or controller of the present disclosure may be distributed among multiple module, processor and/or controller that are connected via interface circuits. For example, multiple modules may provide load balancing. In a further example, a server (also known as remote, or cloud) module may accomplish some functionality on behalf of a client module and/or client station.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A load balancing system comprising:
one or more virtual machines implemented in a cloud-based network and comprising a processor; and
a first load balancing application implemented in the one or more virtual machines and executed by the processor, wherein the first load balancing application is configured such that the processor
receives one or more health messages indicating states of health of a plurality of network appliances, wherein the plurality of network appliances are implemented in an appliance layer of the cloud-based network,
receives a forwarding packet from a network device for a first application server,
based on the one or more health messages, determines whether to perform at least one of a failover process or select a first network appliance of the plurality of network appliances,
performs a first iteration of a symmetric conversion to route the forwarding packet to the first application server via the selected first network appliance,
receives a return packet from the first application server based on the forwarding packet, and
performs a second iteration of the symmetric conversion to route the return packet to the network device via the first network appliance,
wherein during the failover process, the first load balancing application is configured such that the processor switches routing of traffic between the network device and the first application server through a first instance of the first network appliance to routing the traffic between the network device and the first application server through a second instance of the first network appliance.

2. The load balancing system of claim 1, wherein:
the one or more health messages comprise a single health report message received from a processor of a probing application; and
the single health report message indicates the states of health of the plurality of network appliances.

3. The load balancing system of claim 1, wherein:
the one or more health messages comprise a plurality of health messages generated respectively by the plurality of network appliances; and
each of the plurality of health messages indicated a state of health of a respective one of the plurality of network appliances.

4. The load balancing system of claim 1, the performing of:
the first iteration of the symmetric conversion to route the forwarding packet comprises implementation of a hash function on one or more fields of the forwarding packet, and
the second iteration of the symmetric conversion to route the return packet comprises implementation of the hash function on one or more fields of the return packet; and
the hash function provides a same hash value for the forwarding packet as for the return packet.

5. The load balancing system of claim 4, wherein the hash function is an XOR function.

6. The load balancing system of claim 1, wherein:
the first network appliance implements a second load balancing application; and
other ones of the plurality of network appliances are instances of the second load balancing application.

7. A load balancing system comprising:
one or more virtual machines implemented in a public cloud-based network and comprising a first processor and a second processor;
a probing application implemented in the one or more virtual machines and configured such that the first processor (i) transmits a plurality of probe request messages to a plurality of network appliances, (ii) based on the probe request messages, receives a plurality of response messages from the plurality of network appliances, and (iii) based on the response messages, generates a health report message indicating states of health of the plurality of network appliances, wherein the plurality of network appliances are implemented in an appliance layer of the public cloud-based network; and
a first load balancing application implemented in the one or more virtual machines and configured such that the second processor
receives a forwarding packet from a network device for a first application server,
based on the health report, determines whether to perform at least one of a failover process or select a first network appliance of the plurality of network appliances,
performs a first iteration of a symmetric conversion to route the forwarding packet to the first application server via the selected first network appliance,
receives a return packet from the first application server based on the forwarding packet, and
performs a second iteration of the symmetric conversion to route the return packet to the network device via the first network appliance,
wherein during the failover process, the first load balancing application via the second processor switches routing of traffic between the network device and the first application server through a first instance of the first network appliance to routing the traffic between the network device and the first application server through a second instance of the first network appliance.

8. The load balancing system of claim 7, wherein:
the performing of:
the first iteration of the symmetric conversion to route the forwarding packet comprises implementation of a hash function on one or more fields of the forwarding packet, and
the second iteration of the symmetric conversion to route the return packet comprises implementation of the hash function on one or more fields of the return packet; and
the hash function provides a same hash value for the forwarding packet as for the return packet.

9. The load balancing system of claim 8, wherein the hash function is an XOR function.

10. The load balancing system of claim 7, wherein the symmetric conversion is based on a symmetric table such that the symmetric conversion of at least a portion of the forwarding packet provides a same result as the symmetric conversion of at least a portion of the return packet.

11. The load balancing system of claim 7, further comprising a controller implemented in the one or more virtual machines, wherein:
the network device is a client station that is outside the public cloud-based network;
the network device requests a plurality of services; and
the controller, based on the requests for the plurality of services, (i) signals the first processor executing the probing application to enable health monitoring and generate the plurality of probe request messages to monitor the states of health of the plurality of network appliances, and (ii) signals the second processor executing the first load balancing application to perform load balancing for the network device.

12. The load balancing system of claim 7, wherein:
the forwarding packet comprises a first header;
the first load balancing application is configured such that the second processor, based on the health report message, adds a second header to the forwarding packet and forwards the forwarding packet with the second header to the first instance or the second instance;
the return packet comprises a third header; and
the first load balancing application is configured such that the second processor, based on the health report message, adds a fourth header to the return packet and forwards the return packet with the fourth header to the first instance or the second instance.

13. The load balancing system of claim 12, wherein:
the first header of the forwarding packet comprises a first source Internet protocol address and a first destination Internet protocol address;
the second header of the forwarding packet identifies the first network appliance or an Internet protocol address of the first network appliance;
the third header of the return packet comprises a second source Internet protocol address and a second destination Internet protocol address; and
the fourth header of the return packet identifies the first network appliance or an Internet protocol address of the first network appliance.

14. The load balancing system of claim 7, wherein the probing application, the first load balancing application, the plurality of network appliances, and the first application server are implemented in the public cloud-based network.

15. The load balancing system of claim 7, wherein:
the plurality of network appliances are intermediary modules that perform an intermediary service on the forwarding packet prior to the forwarding packet being forwarded to the first application server; and
the first application server terminates a connection with the network device.

16. The load balancing system of claim 7, wherein:
two or more of the plurality of network appliances are implemented in series, such that the forwarding packet passes through the two or more of the plurality of network appliances prior to being received at the first application server; and
the two or more of the plurality of network appliances comprise the first network appliance.

17. The load balancing system of claim 7, wherein:
each of the plurality of network appliances is connected to and configured to route packets to all of a same plurality of application servers; and
the plurality of application servers comprises the first application server.

18. A load balancing method for operating a load balancing system implemented in one or more virtual machines of a cloud-based network, wherein the one or more virtual machines comprises a first processor and a second processor, the method comprising:
executing a probing application on the first processor to transmit a plurality of probe request messages to a plurality of network appliances, wherein the probing application is implemented in the one or more virtual machines;
based on the probe request messages, receiving a plurality of response messages from the plurality of network appliances at the first processor;
based on the response messages and via the first processor, generating a health report message indicating states of health of the plurality of network appliances, wherein the plurality of network appliances are implemented in an appliance layer of the cloud-based network;
receiving a forwarding packet from a network device for a first application server at the second processor,
executing a first load balancing application and based on the health report, determining via the second processor whether to perform at least one of a failover process or select a first network appliance of the plurality of network appliances, wherein the first load balancing application is implemented in the one or more virtual machines;
performing via the second processor a first iteration of a symmetric conversion to route the forwarding packet to the first application server via the selected first network appliance;
receiving a return packet at the second processor from the first application server based on the forwarding packet;
performing via the second processor a second iteration of the symmetric conversion to route the return packet to the network device via the first network appliance; and
while performing the failover process and via the second processor, switching routing of traffic between the network device and the first application server through a first instance of the first network appliance to routing the traffic between the network device and the first application server through a second instance of the first network appliance.

19. The method of claim 18, wherein:
the performing of
the first iteration of the symmetric conversion to route the forwarding packet comprises implementing a hash function on one or more fields of the forwarding packet, and
the second iteration of the symmetric conversion to route the return packet comprises implementing the hash function on one or more fields of the return packet;
the hash function provides a same hash value for the forwarding packet as for the return packet; and
the hash function is an XOR function.

20. The method of claim 18, wherein:
the forwarding packet comprises a first header;
the return packet comprises a second header;
via execution of the first load balancing application and based on the health report message:
adding a third header to the forwarding packet and forwarding the forwarding packet with the third header to the first instance or the second instance, and
adding a fourth header to the return packet, and forward the return packet with the fourth header to the first instance or the second instance, wherein the third header and the fourth header are service chain headers;
the first header of the forwarding packet comprises a first source Internet protocol address and a first destination Internet protocol address;
the second header of the forwarding packet identifies the first network appliance or an Internet protocol address of the first network appliance;
the third header of the return packet comprises a second source Internet protocol address and a second destination Internet protocol address; and
the fourth header of the return packet identifies the first network appliance or an Internet protocol address of the first network appliance.
